(19) United States
(12) Patent Application Publication
(10) Pub. No.: US 2005/0080797 A1
(43) Pub. Date: Apr. 14, 2005

(54) Dynamic lexicon

(76) Inventor: Gordon Short, Palo Alto, CA (US)

Correspondence Address: GLENN PATENT GROUP, 3475 EDISON WAY, SUITE L, MENLO PARK, CA, 94025, US

(21) Appl. No.: 10/938,336

(22) Filed: Sep. 9, 2004

Related U.S. Application Data
(63) Continuation-in-part of application No. 10/649,008, filed on Aug. 26, 2003.
(60) Provisional application No. 60/501,744, filed on Sep. 9, 2003.
(60) Provisional application No. 60/406,010, filed on Aug. 26, 2002.

(51) Int. Cl. G06F 17/00; G06F 7/00; G06F 17/21

(52) U.S. Cl. 707/100; 704/10

(57) ABSTRACT

In a system for content management, a dynamic lexicon allows dictionary and lexical data at NLP (natural-language processing) engines at remote sites to stay current with table data at a central location without suffering the time loss involved in computing new tables at the remote sites, or computing new tables at the central site and distributing them. As new terms are added to the dictionary, each term is assigned a unique token identifier. A first step involves downloading extensions to the table data in real time whenever a new word or expression is encountered. A second step involves periodically updating the table data in real time with recomputed data transmitted in compact data files from the central location. Content items in the local archive are re-indexed based on the updated table data. Maintaining tokens across generations of tables allows documents in different languages to be associated without requiring translation.

### CROSS REFERENCE TO RELATED APPLICATIONS

This Application claims benefit of U.S. Provisional Patent Application Ser. No. 60/501,744, filed Sep. 9, 2003; and is a continuation in part of U.S. patent application Ser. No. 10/649,008, filed Aug. 26, 2003, titled Relating media to information in a workflow system and bearing attorney docket no. SFTO0001, which claims benefit of U.S. Provisional Patent Application Ser. No. 60/406,010, filed on 26 Aug. 2002.

### BACKGROUND OF THE INVENTION

1. Field of the Invention

The invention relates to real time information processing in a computer environment. More particularly, the invention relates to real-time analysis and classification of content.

2. Description of Related Art

In the use of Natural Language Processing (NLP) to analyze text documents to classify, file and subsequently search for those documents (classically known as Knowledge Management), specialized algorithms are used. Typically, these algorithms are a combination of statistical and heuristic algorithms that rely on large data sets of information to support the analysis.

The quality of these sets of information directly impacts the correctness of the NLP analysis and the subsequent quality of the classifying and retrieval of the information. These tables are typically computed using statistical techniques on a comprehensive body of documents. These sets of information are very large and difficult to generate. And further, to the user, the quality of these sets of information is affected by their currency. Therein lies one of the problems addressed herein: how to keep these large sets of information current at many remote sites. One solution is to re-compute these sets of information and transmit them in their entirety to the many sites performing NLP. Yet, this often requires re-examining all of the documents previously entered into the archive and certainly requires the transmittal of large amounts of data from the site where the tables are generated to the site where they are used to support the NLP. It is recognized that updating of lexical data to account for insertion of new documents into an archive is computationally expensive. While a certain amount of drift in the lexical values can occur without a serious loss in retrieval effectiveness, ignoring new terms in newly inserted documents can seriously degrade retrieval.

Another solution is to time-stamp changes to the lexicon and to periodically re-index the lexicon by selecting subsets of objects that have been affected by changes made after a predetermined time variable. However, this solution fails to contemplate the immediate problem posed by addition of new terms in newly inserted items.

A system has been suggested involving a plurality of local dictionaries and a common dictionary management system. As changes are made to local dictionaries, the changes are forwarded to the common dictionary management system. The common system then periodically distributes the updated information to the other local dictionaries. While this solution reduces the computation overhead involved in updating dictionaries, it leads to a situation in which local dictionaries can vary between each other during the period between updates.

### SUMMARY OF THE INVENTION

The present invention is directed to a dynamic lexicon that satisfies these needs. The invention includes one or more remote clients each running local copies of a dictionary and associated lexical tables. As the system encounters new terms, a unique token identifier, which is maintained from generation to generation of the lexical tables, is assigned to each new term. The invention allows updating of the local dictionary in real time by downloading an extension to the tables from a central location whenever a new term is encountered. The extension assigns an implied lexical value to the new term that allows the system to deal with the new term without any significant degradation of content analysis. At predetermined intervals, the client then downloads updates to the dictionary that include newly-computed lexical values for each term in the dictionary. The new values are downloaded to the client in a compact tabular form. By maintaining a constant dictionary of terms, the invention allows the data to be downloaded and placed into the tables without a high degree of structural overhead. Subsequently, content items in the local archive are re-indexed in real time, using the new lexical data. Additionally, the separate stages of the update process can be deployed in content management systems independently of each other. Thus, the invention is also embodied as methods for updating and transmitting lexical tables in real time by extension and by replacement, respectively.

In another aspect, the invention provides a method of associating content items across languages without requiring translation of the documents. The invention includes steps of: assigning a unique token to each word or word, expression or word combination; maintaining the same tokens from generation to generation of the lexical tables; and assigning the same tokens to equivalent words, expressions or word combinations in another language so that tables for the two languages correspond.

Using the invention, it becomes possible to maintain currency of terms among many NLP systems using statistical analysis. Tables can be updated with incremental information on a very timely basis, perhaps at intervals of minutes, or even seconds. Additionally, it is possible to distribute a smaller set of data to update the entirety of the tables on a regular basis, perhaps weekly, or monthly. This solution is scalable to support many different sites performing NLP.

### BRIEF DESCRIPTION OF THE DRAWINGS

FIG. 1 shows a block diagram of a system for content management according to the invention;

FIG. 2 shows a flowchart of a method for updating a lexicon in real time according to the invention;

FIG. 3 shows a flowchart of a method for updating a lexicon in real time by extension according to the invention;

FIG. 4 shows a flowchart of method of updating a lexicon in real time by replacement according to the invention;

FIG. 5 shows a flowchart of a procedure for maintaining currency of an index of documents according to the invention;

FIG. 6 shows a flowchart of a procedure for associating documents across natural languages without translating the documents according to the invention;

### DETAILED DESCRIPTION

The invention is directed to a content management system wherein terms are represented by unique identifiers, or tokens. As a new word is encountered by the NLP engine it is assigned a new token identifier. These token identifiers for the words are maintained from generation to generation of the lexical tables. So any specific word such as ‘cat’ always has the same token identifier over time, and as well, at all client sites. This rule applies also to word combinations that are reduced to a single token, such as ‘United States of America.

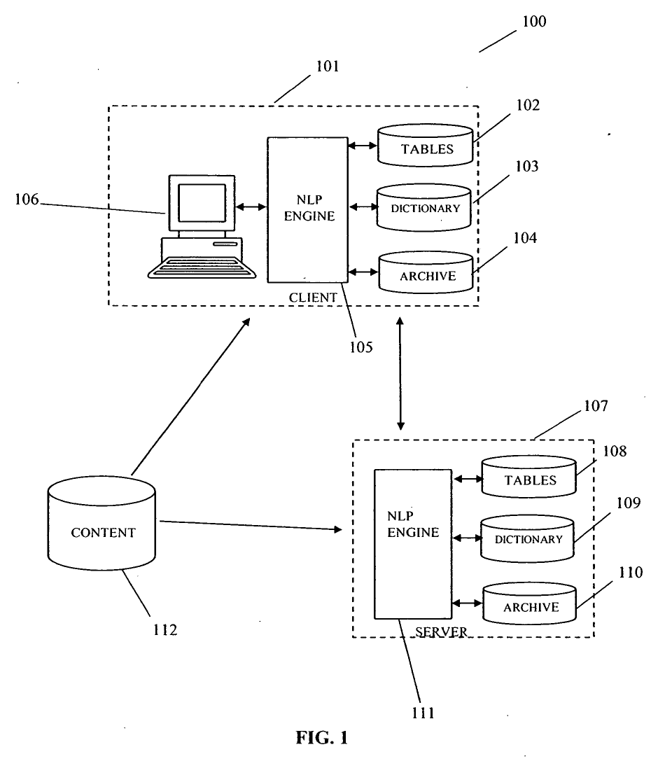

Turning now to the Figures, FIG. 1 shows a block diagram of a system for content management 100 according to the invention. The invented system includes a server 107 and at least one client 101. Residing on the server 107 are an NLP engine 111, an archive 110, a dictionary of terms 109 and a lexicon comprising a plurality of lexical tables 108. Described in greater detail below, the lexicon includes statistical and semantic data regarding the importance and relevance of each term in the dictionary. As described above, each term in the dictionary is denoted by unique token identifier. The server receives a stream of content from a source 112. As the content is received by the server, the NLP engine 111 performs a statistical and semantic analysis of each content item, generating a signature for each item. The invention uses a signature algorithm, described in detail in the parent application, Ser. No. 10/649,008. Each item has a unique signature that can be used to distinguish it from any other item. A signature is a vector of words and their weighting within the document. The weighting is determined by the importance of the word in collocations and within the document.

The items and the accompanying signatures are deposited in the archive 110. The lexical tables are constructed from the semantic and statistical data generated during the NLP analysis of the various content items. More will be said about the lexical tables below.

In communication with the server 107 is a client 101. The embodiment of FIG. 1 is for the purpose of illustration only and is not intended to limit the invention. In actual practice, the invention may include a plurality of clients, each in communication with the server. In fact, a major advantage of the solution provided by the invention is its scalability to systems involving large numbers of clients. The client 101 includes engine 105, archive 104, dictionary 103 and tables 102. As content items are received from a source 110, they are analyzed by the NLP engine 105, based on the dictionary and tables, 103 and 102, respectively and deposited in the archive 104.

Additionally, the client includes an interface component 106 whereby an operator of the client 101 uses and interacts with the system 100.

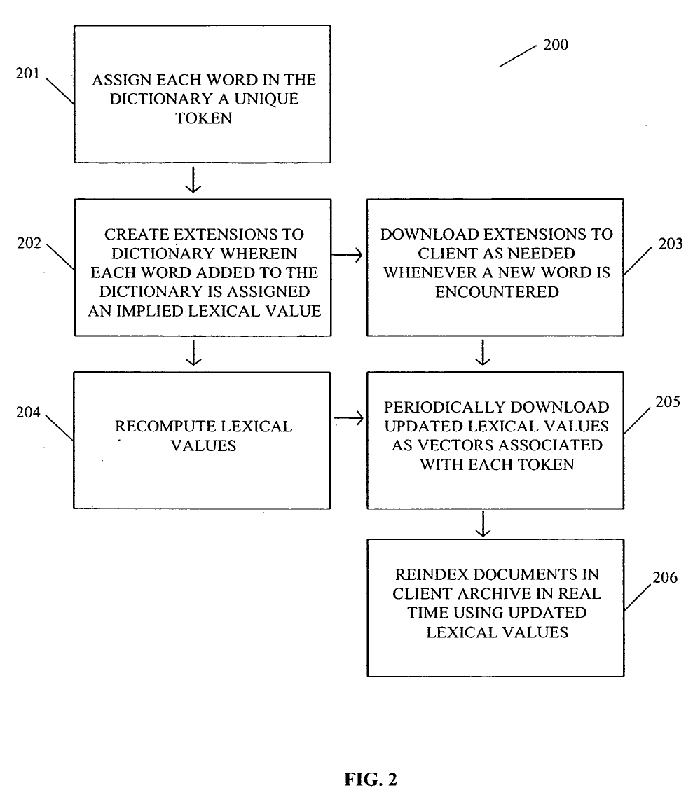

As the content management system is running, the client 101 encounters new words that are not in the dictionary and lexicon of the client. For example, the medical term SARS (Severe Acute Respiratory Syndrome), before its first appearance in the media, was theretofore unknown. Therefore, the importance and associations of the word would have been unknown to an NLP system encountering the term for the first time. Yet, within a very short period of time after the appearance of this word in the news, perhaps a minute or less, content management systems needed to recognize this term and associate it appropriately within the archive of documents in the system. The solution is for each client 101 to work from an extensible dictionary and lexical tables that are distributed from a central location, i.e. the server 107. As shown in FIG. 2, the invention provides a method 200 of updating the client lexicon and dictionary in real time by downloading updates from the server. The method includes steps of:
assigning each word in the dictionary a unique token 201;
creating extensions to the dictionary wherein each term added to the dictionary is assigned an implied lexical value 202;
downloading extensions to the client in real-time whenever a new word is encountered 203;
periodically re-computing lexical values at the server 204;
periodically downloading updated lexical values as vectors associated with each token 205; and
re-indexing documents in the client archive in real time using updated lexical values 206.

As previously described, as new terms are added to the server dictionary, each term is assigned a unique token ID. Updating the client dictionary and lexicon by extension is made possible by the maintenance over time of a constant token ID value for each term in the dictionary. This is important so that the prior dictionary and lexical tables are still applicable to the analysis. As new terms are added to the server dictionary, extensions to the dictionary are created wherein each term is assigned an implied or a “cheater” lexical value. Because the process must occur in real time, there is insufficient time to re-compute the entire set of tables. Instead, an implied statistical value for the word, word combination or phrase taken from like words, word combinations or phrases from the tables is used for the new word. It is important, however, that the implied lexical value be carefully selected and that the number of implied values be kept below a level at which the quality of the analysis is unduly affected. While the lexical values for each term are unique and are calculated using an extensive procedure, for short-term use, as long as they are selected in a manner as to minimize error, implied values can be supplied to the client for use on a temporary basis. For example, encountering the word ‘Birmingham,’ and knowing it is a city, one could look up the lexical value of a similar city and substitute that ‘cheater’ value for temporary use. It should be appreciated that the selection and assignment of implied values is preferably automated. Once the entire lexicon is recalculated, the word ‘Birmingham’ is assigned its rightful value. Thus, the implied value is a borrowed value that will be calculated correctly once the entire lexicon is recomputed. Error is minimized by choosing a cheater value wisely. For example, one would not necessarily choose a cheater for ‘egret’ by looking up ‘snakes’, even though both are animals. One would do better to look up a similar animal that is already known in the lexicon. Thus, through careful assignment of implied values, and by keeping them to a minimum in the lexicon, the implied lexical values provide the data necessary for the NLP engine to deal with the new terms appropriately.

When a new term is encountered, an extension to the central copy of the dictionary and lexical tables is downloaded by each client to update its local working copy of the data tables. Because only the extension information is downloaded, the amount of data is minimal, typically less than one kilobyte of data. Thus, in the extension stage, the local dictionary and lexical tables are extended slightly to account for new, emerging terms.

Over time, extensions to the tables unbalance the NLP analysis of the text documents sufficiently to impact the quality of the relating. Before, or when this becomes noticeable, the statistical tables are updated with new, calculated values for each of the dictionary tokens. This is accomplished by downloading the new values in a compact tabular form. By maintaining a constant dictionary of words, word combinations and phrases, it is possible to structure the statistical tables to maintain their order subsequently, thus making it possible to download the data without structural overhead, and place it into the tables. The token values are sequential from 1 and counting upward for each unique word or word combination that is recognized by the NLP engine. The lexical tables are vectors of values to associate with each token. The table may be downloaded as a vector where the offset in the data is the corresponding token value. Thus, a complete update to the tables can be downloaded to the client system without the necessity of downloading the entire dictionary and lexicon.

Then, as a final step, the content items in the archive already indexed must be re-indexed using the new statistical tables. This process proceeds in real time even as the knowledge management system is running, such that some portion of the documents is not re-signed. This portion decreases as the re-indexing proceeds. The invention assumes that the mixing of the two signature sets into one content management system does not unduly affect the quality of the relating providing that the degree of unbalance in the lexical tables is minimized. The ‘balance’ of the lexicon refers to the statistical results for each word, which are based on the entire reference set of documents. Thus, if during re-indexing, the system includes signatures computed from implied lexical values and calculated lexical values, the system is unbalanced. However, if the proportion of the signatures is kept to an acceptable threshold, the degradation in the quality of the statistics is also kept to an acceptable level. In this way, although the statistics are not wholesome, the error is kept to a level that does not unduly change the results of the calculations. If the update stage is performed in a timely fashion, the degree to which the signatures of the documents already analyzed are wrong is small enough that the NLP system will continue to function with a mixture of documents signed by the old lexical tables and documents signed using the new lexical tables. Nevertheless, it is preferable that all of the document signatures are brought up to date to provide the highest quality of analysis, and further, to avoid additional degradation with the extending and updating of the new tables when even more terms are discovered.

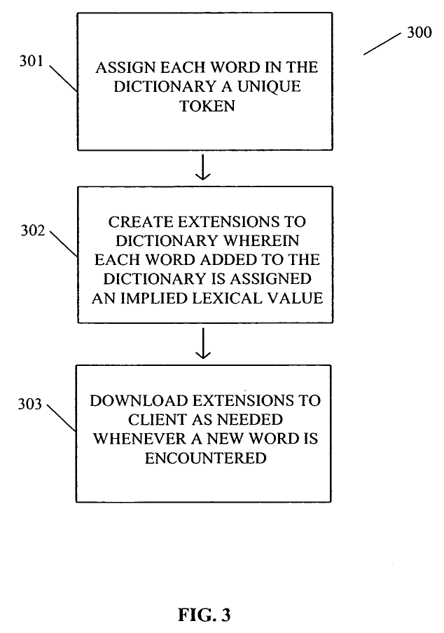

The above steps of updating the client dictionary and lexicon by extension and updating the client dictionary and lexicon by replacement can also be employed independently of each other. Thus, as shown in FIG. 3, an embodiment of the invention provides a method 300 for updating a lexicon in real time by extension that includes steps of:
assigning each term in the dictionary a unique token 301;
creating extensions to the dictionary wherein each word added to the dictionary is assigned an implied lexical value 302; and
downloading extensions to a client as needed whenever the client encounters a new term 303.

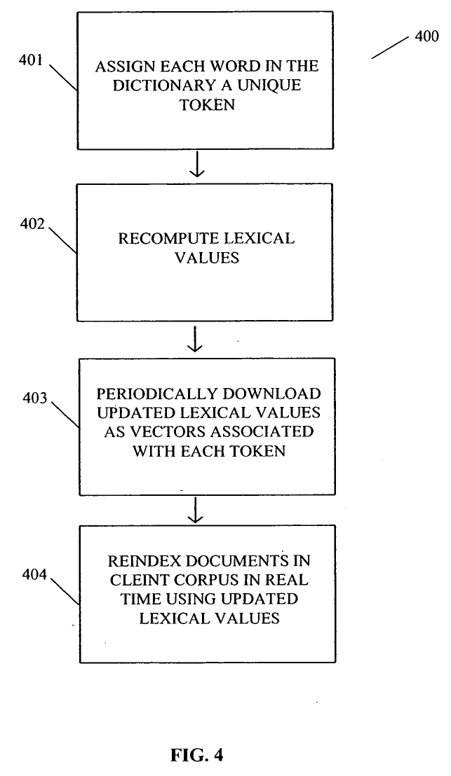

As shown in FIG. 4, an embodiment of the invention provides a method 400 for updating a lexicon in real time by replacement that includes steps of:
assigning each word in the dictionary a unique token 401;
re-computing lexical values 402;
periodically downloading updated lexical values as vectors associated with each token 403;
re-indexing documents in the client archive in real time using updated lexical values 404.

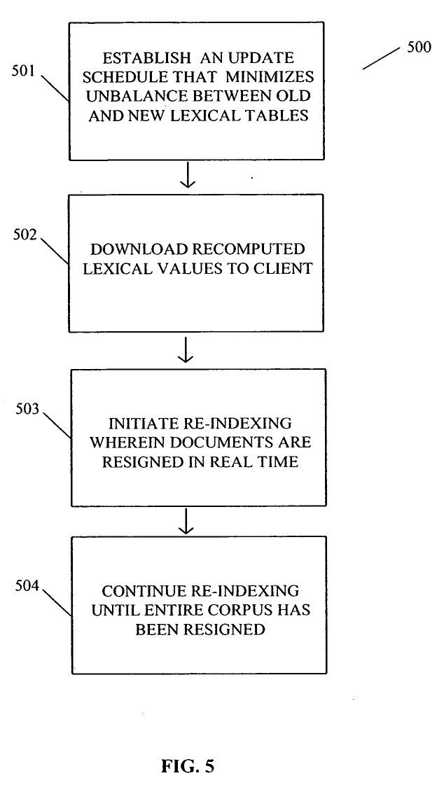

As shown in FIG. 5, an embodiment of the invention provides a method 500 for maintaining currency of an index of documents that includes steps of:
establishing an update schedule that minimizes unbalance between old and new lexical tables 501;
downloading re-computed lexical values to client 502;
initiating re-indexing wherein documents are resigned in real time 503;
continuing re-indexing until entire archive has been resigned 504.

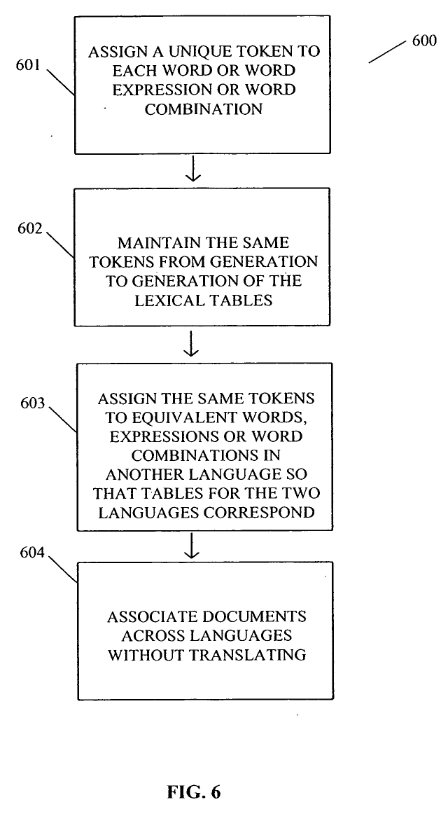

Consistent assignment of token identifiers also makes it possible to relate documents written in separate languages without translating. A word in a first language is assigned a consistent token identifier. The equivalent word in another language is assigned the same token. This means that lexical tables from one language, such as English; correspond to lexical tables for another language, such as French. Advantageously, one uses the token identifier for a particular word in one language to refer to a second language's lexical table for the translation of the word in the second language. The solution allows documents to be easily associated across different languages by using the token identifiers, and without having to translate the document. Thus, as shown in FIG. 6, an embodiment of the invention provides a method 600 of associating documents across languages without translation that includes steps of:
assigning a unique token to each word or word expression or word combination 601;
maintaining the same tokens from generation to generation of the lexical tables 602;
assigning the same tokens to equivalent words, expressions or word combinations in another language so that tables for the two languages correspond 603; and
associating documents across languages without translating 604.

This is a significant advantage of the invention's ability to provide classification, searching, and retrieval of documents across multiple languages, thereby greatly enhancing NLP analysis.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method of transmitting dictionary updates in a system for real-time analysis of content comprising steps of:
providing a local copy of a dictionary and associated lexical tables;
downloading extensions to said dictionary and said tables as needed to account for new terms from a central location, wherein said extensions assign implied lexical values to said new terms;
periodically downloading from said central location newly-computed lexical values for each term in said dictionary; and
re-indexing documents in a local archive in real time based on said newly-computed lexical values.

2. The method of claim 1, further comprising a step of assigning a unique identifier to each term in said dictionary.

3. The method of claim 2, wherein said unique identifier comprises a tag.

4. The method of claim 2, wherein lexical data for a term is organized in said lexical tables and associated with said unique identifier for said term.

5. The method of claim 2, further comprising a step of:
supplying an implied lexical value for a first term by borrowing a lexical value for a term closely resembling said first term.

6. The method of claim 1, wherein said step of periodically downloading comprises any of the steps of:
when the number of new terms exceeds a predetermined threshold, re-computing said lexical tables and distributing to user sites; and
when a predetermined period of time has passed, re-computing said lexical tables and distributing to user sites.

7. The method of claim 1, wherein said step of periodically downloading comprises downloading said newly-computed values in compact, tabular form.

8. The method of claim 2, wherein a lexical table comprises a vector of values to be associated with a unique identifier.

9. The method of claim 2, wherein a table is downloaded as a vector where an offset in the data comprises said unique identifier, wherein the amount of data distributed to a user's system is kept minimized.

10. The method of claim 1, wherein the step of re-indexing documents comprises re-indexing the documents as the system is running.

11. The method of claim 1, wherein the step of re-indexing documents comprises computing a new signature for each document.

12. The method of claim 11, wherein said system runs having a mixture of documents having old lexical tables mixed with documents having new lexical tables.

13. The method of claim 11, wherein all document signatures are brought up to date.

14. A process for updating a lexicon in real time by extension, comprising steps of:
assigning a unique token to each term in a dictionary;
creating extensions to the dictionary wherein each term added to dictionary is assigned an implied lexical value;
transmitting an extension to lexical tables incorporating said implied values to a client when an analysis at said client machine first encounters a new term.

15. A process for updating a lexicon in real time by replacement comprising steps of:
assigning a unique token to each term in a dictionary;
periodically re-computing lexical values for said dictionary;
periodically downloading recomputed lexical values as vectors to a client, wherein each vector is associated with a token; and
re-indexing items in said clients archive in real time using said re-computed lexical values.

16. A method for maintaining currency of an index of content items comprising steps of:
establishing an update schedule that minimizes unbalance between old and new lexical tables;
downloading re-computed lexical values to a client;
initiating re-indexing of an archive at said client wherein items are resigned in real time; and
continuing re-indexing until the entire archive has been resigned.

17. A content management system comprising:
a server;
at least one client; and
means for dynamically transmitting dictionary updates from said server to said at least one client for real-time analysis of content.

18. The system of claim 34, wherein said means for dynamically transmitting dictionary updates from said server to said at least one client for real-time analysis of content comprises
means for downloading down loading extensions to a dictionary and said lexical tables at said client from said server as whenever a new term is encountered, wherein said extensions assign implied lexical values to said new terms;
means for periodically downloading from said server newly-computed lexical values for each term in said dictionary; and
means for re-indexing documents in a client archive in real time based on said newly-computed lexical values.

19. The system of claim 18, further comprising means for assigning a unique identifier to each term in said dictionary.

20. The system of claim 19, wherein said unique identifier comprises a token.

21. The system of claim 19, wherein lexical data for a term is organized in said lexical tables and associated with said unique identifier for said term.

22. The system of claim 19, further comprising means for:
supplying an implied lexical value for a first term by borrowing a lexical value for a term closely resembling said first term.

23. The system of claim 18, wherein said means for periodically downloading comprises means for any of:
when the number of new terms exceeds a predetermined threshold, re-computing said lexical tables and distributing to user sites; and
when a predetermined period of time has passed, re-computing said lexical tables and distributing to user sites.

24. The system of claim 18, wherein said mean for periodically downloading comprises downloading said newly-computed values in compact, tabular form.

25. The system of claim 24, wherein a table comprises a vector of values to be associated with a unique identifier.

26. The system of claim 25, wherein a table is downloaded as a vector where an offset in the data comprises said unique identifier, wherein the amount of data distributed to a user's system is kept minimized.

27. The system of claim 18, wherein the step of re-indexing documents comprises re-indexing the documents as the system is running.

28. The system of claim 18, wherein the step of re-indexing documents comprises computing a new signature for each document.

29. The system of claim 28, wherein said system runs having a mixture of documents having old lexical tables mixed with documents having new lexical tables.

30. The system of claim 28, wherein all document signatures are brought up to date.

31. A method of associating documents across languages without translation in a content management system that includes a lexicon comprising steps of:
assigning a unique token to each term;
maintaining the same tokens from generation to generation of lexical tables;
assigning the same tokens to equivalent words, expressions or word combinations in another language so that tables for the two languages correspond; and
associating documents across languages without translating based on said corresponding tables.
